(19) United States
(12) Patent Application Publication
(10) Pub. No.: US 2006/0223403 A1
(43) Pub. Date: Oct. 5, 2006

(54) Three Layer Thermoplastic Synthetic Leather Product and Macufacture Thereof

(76) Inventor: Asif Mahboob, Whitehouse, OH (US)

Correspondence Address: ASIF MAHBOOB, 11255 WATERVILLE-SWANTON ROAD, WHITE HOUSE, OH, 43571, US

(21) Appl. No.: 10/907,551

(22) Filed: Apr. 5, 2005

(51) Int. Cl. D04H 1/08; B32B 27/12

(52) U.S. Cl. 442/320; 442/324; 442/394

(57) ABSTRACT

An imitation leather product consisting of Polyurethane film laminated to Polyester fleece fabric with Polyurethane glue used as a binder. Said material exhibits qualities suitable for use as synthetic leather when embossed with an appropriate texture.

The present invention is a product suitable for use as a leather substitute consisting of three laminated and embossed layers. It gains its leather imitating qualities from the combined characteristics of said layers, with differing degrees of influence.

The topmost layer—that being the one facing the environment—is a polyurethane film being no less than 2 MIL thick. This acts as a binder for the woven fibers of the fleece fabric below, allowing restricted stretching of the material while holding the fibers preventing deformation by de-lamination. It also provides a smooth surface, which can be embossed with the appropriate texture.

The intermediate layer is polyurethane glue that acts to bind the film and the fleece. This aids in the durability and longevity of the final product by making de-lamination significantly more difficult. The glue can also act to stiffen the material slightly, giving it a feel more reminiscent of leather found in apparel. The consistency and amount of glue can be adjusted to produce the desired qualities in the final product.

The bottommost layer consists of sweatshirt fleece fabric. The film and the glue are applied to the top, knit side of the material; the brushed side being the underside of the finished product. The weight of the fabric is the most significant factor in the simulation of leather, giving the product its soft, leather-like feel.

After the lamination process is complete, the product is embossed to a desired texture. The product may be embossed with a wide variety textures, and one is chosen to match the qualities defined by the component composition.

What is claimed is:

1. A product suitable for use as a leather replacement.

2. A product as in claim 1, consisting of three laminated and embossed layers.

3. Three layers as in claim 2, the topmost being Polyurethane film being no less than 2 MIL thick.

4. An intermediate layer as in claim 3 consisting of Polyurethane glue, the consistency and amount being adjusted to suit manufacturing and aesthetic needs.

5. A bottommost layer as in claim 3 consisting of Polyester fleece fabric, the weight depending on aesthetic requirements.

6. A final embossing as in claim 2, to produce the visual simulation of natural leather.
